(19) United States
(12) Patent Application Publication
(10) Pub. No.: US 2018/0164435 A1
(43) Pub. Date: Jun. 14, 2018

(54) DUAL LENSE LIDAR AND VIDEO RECORDING ASSEMBLY

(71) Applicant: Digital Ally, Inc., Lenexa, KS (US)

(72) Inventor: Matthew R. ANDREWS, Lenexa, KS (US)

(21) Appl. No.: 15/374,401

(22) Filed: Dec. 9, 2016

(51) Int. Cl. G01S 17/02; G01P 3/36; G01P 1/02; G01S 7/48; G01S 7/51; H04N 5/225; H04N 5/77; H04N 7/18

(52) U.S. Cl. CPC G01S 17/023; G01P 3/36; G01P 1/026; H04N 7/183; G01S 7/51; H04N 5/2252; H04N 5/77; G01S 7/4808

(57) ABSTRACT

A system and method for determining the speed of a vehicle via laser measurement includes a digital camera to capture a still or moving image of the vehicle. The light captured by the camera is captured simultaneously and collinearly with the reflected laser to insure that the vehicle imaged is traveling at the calculated speed.

### BACKGROUND

### 1. Field

Embodiments of the invention are broadly directed to systems and methods of imaging a moving object and determining its speed. More specifically, embodiments of the invention employ LIDAR techniques to calculate the speed of an object, such as a vehicle, while simultaneously generating an image of the object with a shared perspective of the scene.

### 2. Related Art

Light RADAR or “LIDAR” systems transmit a laser beam at a target such as an object, set of objects, or region, collect the reflected beam, and analyze differences between the transmitted and reflected beam to make remote measurements of the target. Such systems have been used across diverse fields including geology, meteorology, and robotics. One particular application of a LIDAR system is to measure a change in wavelength or frequency of a laser reflected from a moving object to determine the object's speed. This application is often employed by law enforcement officers to determine whether or not a vehicle is exceeding a speed limit.

A potential weakness of typical LIDAR speed measurement systems is the possibility that the collected reflection of the transmission beam may have been reflected from an object other than the intended target vehicle. When this happens, a calculated speed can be attributed incorrectly to a given vehicle. For instance, a beam transmitted by a LIDAR device may be reflected from a car driving in an adjacent lane to the target car. The device may calculate a speed exceeding the local speed limit, and attribute this speed to the target car when it was actually driving just under the limit. Even in cases where this misattribution has not happened, the ambiguity about what object reflected the transmitted beam could raise validity questions about the documentation of an incident that could lead to failure to properly prosecute someone who has committed a traffic violation. For instance, a defendant may argue in court that an officer's measurement could be attributed to any of a number of vehicles within a close proximity to theirs, calling into question the legitimacy of speeding charges.

Some systems and methods for LIDAR speed detection attempt to address these concerns by generating an image of the target object (in this case, a moving vehicle), proving that the officer correctly measured the speed of the accused vehicle. Typically, this is done using a built-in camera, separate from the speed determination system, which takes a picture of the target vehicle at the moment of beam transmission or reception. However, since the picture is taken from a slightly different angle than the reflected beam is received, ambiguity may still exist as to whether or not the imaged vehicle was the reflecting object. What is needed is a LIDAR device for speed determination that generates an image in such a way that reliably determines and proves that the imaged object is moving at the calculated speed.

### SUMMARY

Embodiments of the invention provide systems and methods for imaging and determining the speed of an object. A first embodiment of the invention is directed to a LIDAR device for imaging an object and determining its speed including a beam source, lens, beam receiver, photodiode, first beam splitter, and processor. The beam source generates a transmission beam that reflects off the object, and is thereafter collected along with visible light by the lens. The visible light and reflected beam are separated by the beam splitter and directed towards the beam receiver and photodiode, respectively. The processor then analyzes the reflected beam to calculate the speed of the object and generates a corresponding image.

A second embodiment of the invention is directed to a method of imaging and determining the speed of an object. A transmission beam is generated from a beam source and directed at the object. Thereafter, a commingled light sample including the reflected beam and a visible light sample is collected and split by a beam splitter. The reflected beam is directed towards and detected by a beam receiver, while the visible light sample is directed towards and collected by a photodiode. Finally, a processor analyzes the collected light to calculate the speed of the object and generate an image. The calculated speed, generated image, and a set of metadata related to the calculation and/or generation may be stored in a non-volatile memory unit.

A third embodiment of the invention is directed to a shared-perspective LIDAR system for imaging and determining the speed of an object. The system includes a beam source, lens, beam splitter, beam receiver, photodiode, processor, non-volatile memory unit, and recording device manager. The beam source generates a transmission beam that reflects off the object, and is thereafter collected along with visible light by the lens. The visible light and reflected beam are separated by the beam splitter and directed towards the beam receiver and photodiode, respectively. The processor analyzes the reflected beam to calculate the speed of the object and produces an image of the object from the visible light sample captured by the photodiode. Finally, the recording device manager stores the speed of the object and the image of the object in the non-volatile memory unit.

This summary is provided to introduce a selection of concepts in a simplified form that are further described below in the detailed description. This summary is not intended to identify key features or essential features of the claimed subject matter, nor is it intended to be used to limit the scope of the claimed subject matter. Each of the above embodiments may include further recording devices, hardware, or steps not explicitly described. Other aspects and advantages of the invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 is a diagram of elements comprising embodiments of the invention;

FIG. 2 is a side view of an embodiment of the invention;

FIG. 3 is a front view of an embodiment of the invention;

FIG. 4 is a rear view of an embodiment of the invention;

FIG. 5 is a block diagram of elements included in embodiments of the invention;

FIG. 6 is a lateral cross-section of an embodiment of the invention;

FIG. 7 is a front-to-back cross section of an embodiment of the invention;

FIG. 8 is a top-down cross-section of an embodiment of the invention; and

FIG. 9 is a flow diagram of steps that may be performed in embodiments of the invention.

The drawing figures do not limit the invention to the specific embodiments disclosed and described herein. The drawing figures are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Embodiments of the invention provide systems and methods of determining the speed of a moving object, particularly of moving vehicles. A beam of light is generated within a LIDAR device and directed towards the object. The beam of light reflects back to the device and is collected along with visible light as a commingled light sample. The reflected beam and visible light are split from the commingled light sample and collected to calculate the speed of the object and generate an image of the object. The resulting image is generated from visible light that is collinear with the reflected beam, which insures that the imaged object is the same object measured by the device to be traveling at the calculated speed. Thus, the shared perspective between the speed calculation components and the components generating the image removes any ambiguity about the accuracy and legitimacy of the speed determination.

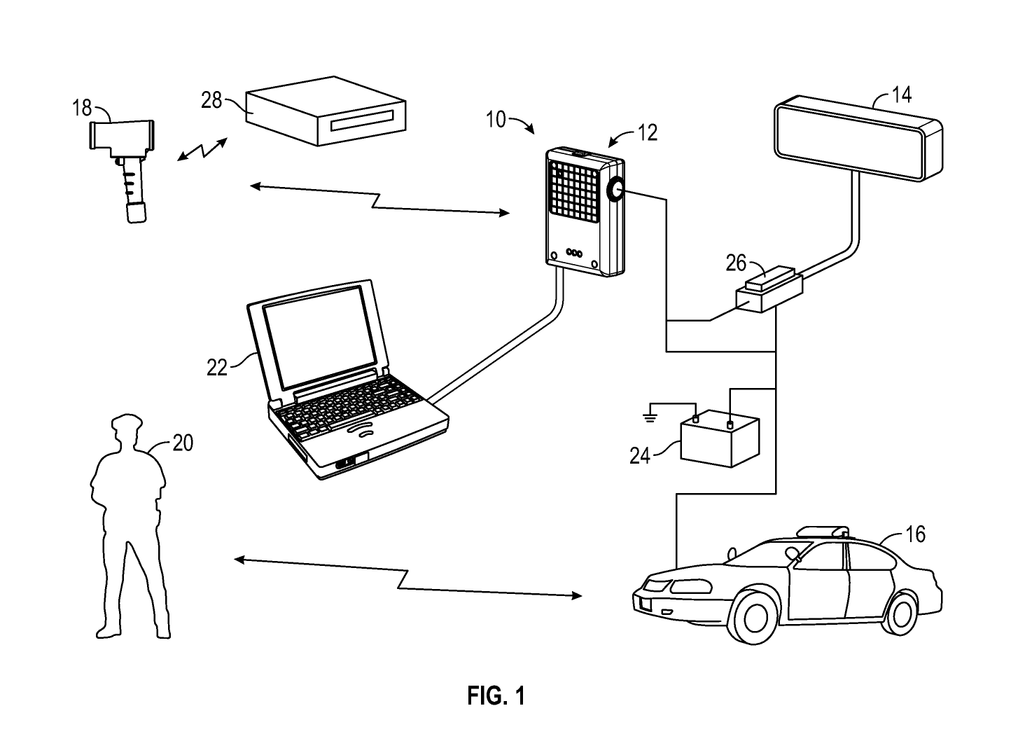

Turning to the figures, and particularly FIG. 1, a first embodiment of a recording system 10 is described. FIG. 1 includes an intermediate recording device manager 12 (or “manager 12”), a vehicle recording device 14 mounted in a vehicle 16 such as a police vehicle and communicatively coupled (i.e., synced) to the recording device manager 12, and a LIDAR device 18. LIDAR device 18 may be carried by a police officer 20 and wirelessly synced to the recording device manager 12. The recording device manager 12 is operable to detect when the vehicle recording device 14, LIDAR device 18, or any other synced device in range has started operating and to broadcast or transmit a signal to other synced recording devices in range, instructing recording by the respective device. The recording device manager 12 may also generate time stamps and unique serial numbers for a data recording, and create or collect metadata and transmit such time stamps, unique serial number, and other metadata to the recording devices 14, 18 for corroborating the recorded data. For illustrative purposes, the recording system 10 includes the vehicle recording device 14 and the LIDAR device 18, but it will be understood that duplicate or additional devices, such as audio recorders, thermal imagers, body cameras, security cameras, radios, radar scanners, positioning devices, etc. can be synced to the recording device manager 12. Specifically, multiple recording devices 14, 18 can be synced with the manager 12 simultaneously.

In embodiments of the present invention, the vehicle recording device 14 and LIDAR device 18 may each include one or more cameras operable to record data, including without limitation, audio, photographic, and video data. Moreover, the recording devices 14, 18 are also operable to record or generate metadata associated with the recording, such that the data recorded by the devices 14, 18 includes the audio data, the video data, and/or the metadata associated with either or both of the audio and video data. Examples of metadata for an audio or video recording include a location (as determined by a GPS) where the data was recorded, a user who recorded the data or was otherwise associated with the recording device 14, 18 (e.g., an officer driving a police vehicle or an officer operating the LIDAR device 18), the time stamp and/or unique serial number, a trigger for the data recording event (i.e., what prompted a data capture scan by any of the recording devices), etc.

The recording device manager 12 is illustrated in FIG. 1 as a standalone device but in some embodiments can be incorporated into other devices, such as a laptop (including external computing device 22), a radio, a recording device (including the vehicle recording device 14), or a mobile communications device. The recording device manager 12 may be permanently or removably mounted anywhere in the police vehicle 16, such as on the dashboard, center console, or windshield. Alternatively, the recording device manager 12 can be carried or worn by the police officer 20, such as on his utility belt or in his pocket.

As further shown in FIG. 1, an external computing device 22 may be coupled to recording device manager 12 via wired or wireless connection. The external computing device 22 can be a laptop, tablet, mobile device, smartphone, or other computing device. The external computing device 22 displays a graphical user interface (GUI) by which the police officer 20 or other user may view recorded data and/or measurements and make selections regarding the recording system 10. External computing device 22 may function as an input/output device to allow an officer to judge the quality of a still or video image captured by LIDAR device 18. External computing device 22 may include a central processing unit (CPU) and one or more random-access memory (RAM) modules, as well as a graphics card and display for user interaction. In some embodiments no display is present, while in others it may be spaced apart from and coupled to and external computing device 22. Similarly, peripherals such as keyboard and mouse may be coupled to external computing device 22. Like the display, these peripherals may be integrated into external computing device 22 or absent. External computing device 22 may be touch-sensitive, allowing an officer to input data or make selections via tap, swipe, or other gesture.

A system power source 24 may be electronically connected to the recording device manager 12 through dedicated wiring. The system power source 24 supplies power to each of the electronic components of the recording device manager 12 and, in embodiments of the present invention, to the vehicle recording device 14. In embodiments of the invention, the system power source 24 is the police vehicle's battery but can be another power source, such as a battery cartridge of the external computing device 22 or the vehicle recording device 14.

The electronic connection between the recording device manager 12 and the vehicle recording device 14 optionally includes a control area network (CAN) bus 26, which “directs traffic” for incoming and outgoing signals based on indicated importance or other factors and follows an algorithm for determining the order in which (or whether) signals are transmitted.

The vehicle recording device 14 is operable to record audio, video, and/or other data. In some embodiments, the recording device 14 is a video recording device such as one produced by Digital Ally, Inc., including the DVM100, DVM250, DVM250Plus, DVM250Law, DVM400, DV440Ultra, DVM470, DVM500, DVM500Plus, and DVM750. As described below, in some embodiments the recording device 14 is operable to receive a signal of a triggering event, while in other embodiments the recording device 14 utilizes the CAN bus 26 and is operable to receive time stamps and metadata in addition to the signal of a triggering event. The vehicle recording device 14 can be incorporated into the police vehicle's rear view mirror, dashboard, spotlight, or other locations associated with the police vehicle 16 and may receive power from the power source 24 through dedicated wiring. In addition to the exemplary vehicle recording devices listed above, a vehicle recording device is further described in commonly-owned U.S. Pat. No. 8,520,069, issued Aug. 27, 2013, entitled “Vehicle-Mounted Video System with Distributed Processing,” and the entirety of which is incorporated by reference herein.

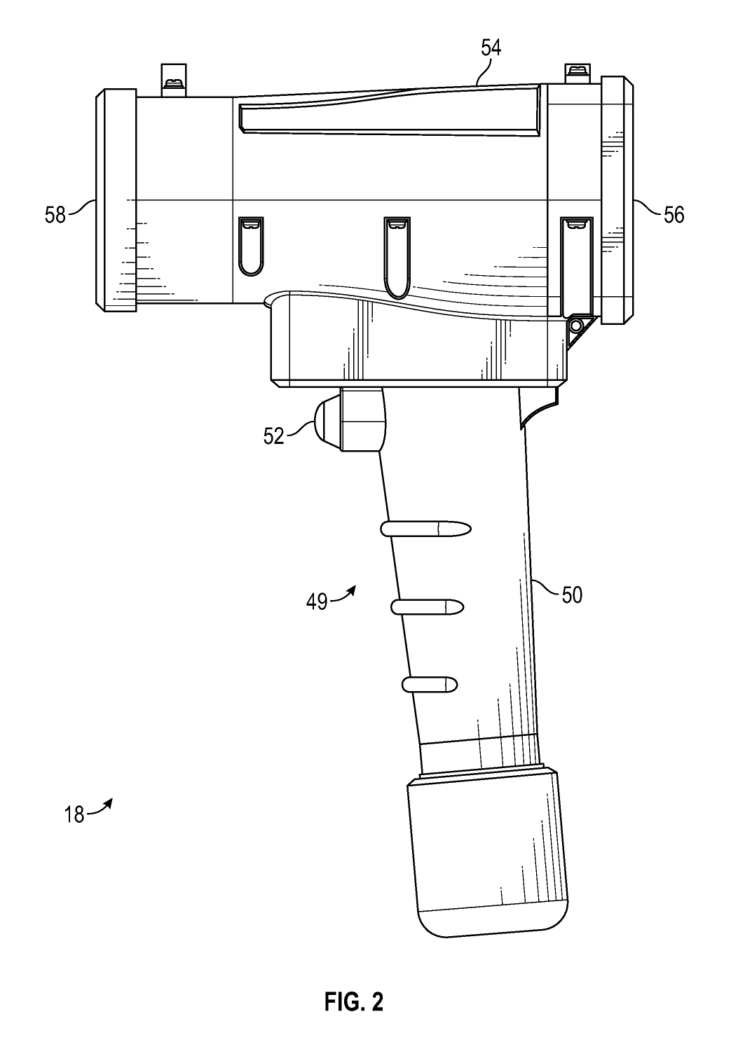

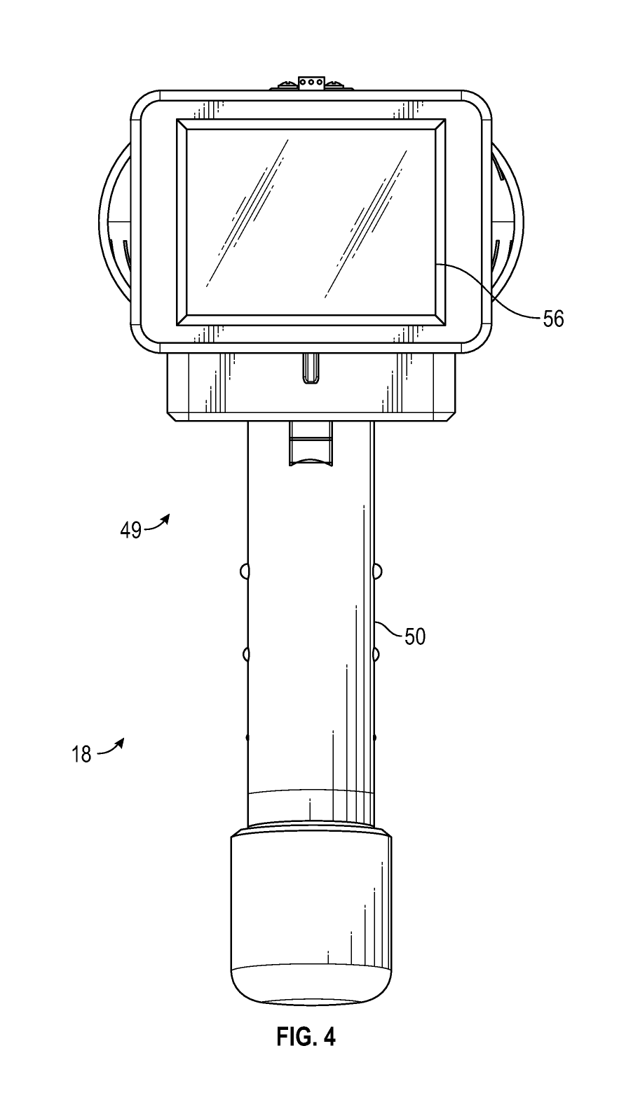

LIDAR device 18 may be a handheld device formed in a substantially gun-shaped housing 49, as seen in FIGS. 2-5. The housing 49 may include at least a handle portion 50, trigger portion 52, and head portion 54. One or more lenses may be located at the front 58 of the device, while a visual display 56 may be positioned at the rear of the device. Visual display 56 provides an electronic display of a calculated speed of a moving object and/or a generated image of the object. This structure is intended only as example, and is not meant to be limiting in any way. In fact, LIDAR device may not be handheld at all, but rather integrated into the structure of a patrol vehicle or other large piece of equipment. Housing 49 may include a handle portion 50, trigger portion 52, and head portion 54 without being substantially gun-shaped.

Visual display 56 positioned at the rear of head portion 54 may be provided by a liquid crystal display (LCD), or may be any other electronic display screen, such as a plasma screen. Visual display 56 may be touch-sensitive, allowing an officer to input data or make selections via tap, swipe, or other gesture. As further discussed below, visual display 56 may operate to display the calculated speed of the object and/or captured image of the object, as well as metadata related to captured or calculated information, and/or controls for controlling the operation of the device. Visual display 56 may display any or all of these elements layered in a superimposed manner on the screen at a single time. The visual display 56 may further be operable to display an image of the scene prior to performing a speed measurement to aid a user in accurately aiming the device at the desired target. Such an aiming assist function may be in response to a partial activation of trigger portion 52 or a separate control.

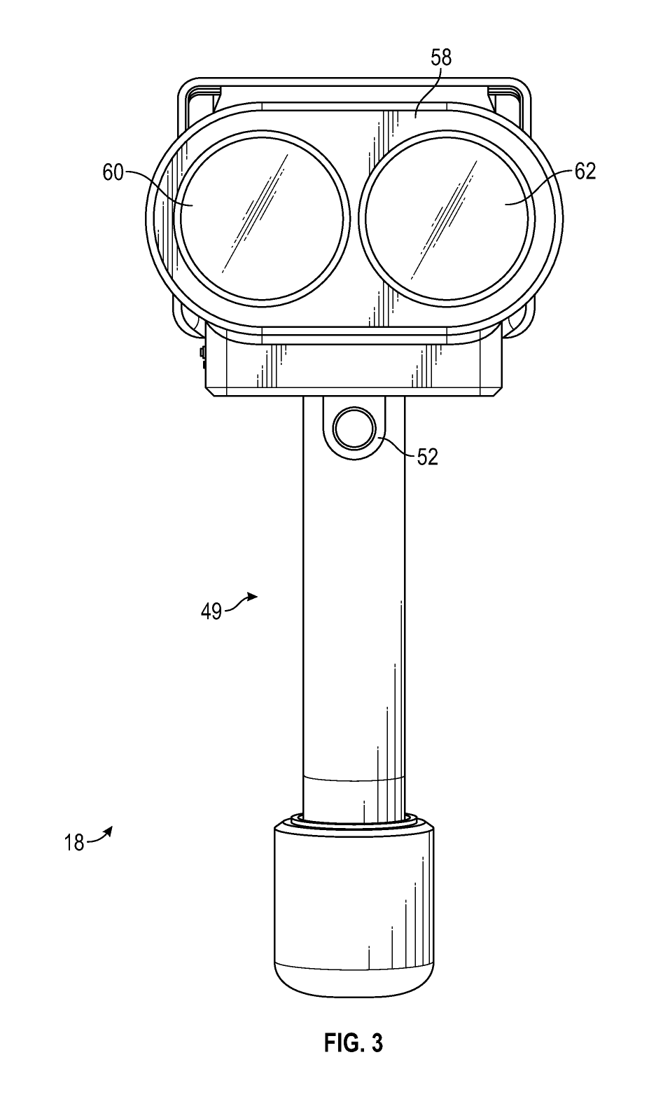

At the front of LIDAR device 18, opposite visual display 56, is front portion 58. As seen in FIG. 3, in some embodiments front portion 58 includes a plurality of lenses that allows light to enter and exit the housing 49 of the device 18. The embodiment displayed in FIG. 3 includes two lenses, transmission lens 60 and reception lens 62, but this is not intended to be limiting. Transmission lens 60 and reception lens 62 are contained within housing 49 of LIDAR device 18 in that they are mounted in housing 49, but in some embodiments each lens may be wholly or partially exposed to the external environment. Embodiments of the invention may alternatively include additional lenses for projection and reception of light or only a single lens operable to perform both functions. As will be discussed further below, transmission lens 60 permits the passage of a transmission beam, generated from a beam source 64 within the housing 49 of LIDAR device 18. The transmission beam is focused by transmission lens 60 and directed towards the target object, such as a moving vehicle. After reflection from the target object, the beam, which is now termed a reflected beam, is allowed to pass back into the housing 49 of the LIDAR device 18 via reception lens 62. Reception lens 62 is further operable to collect a visible light sample reflected from the target object, permitting its passage into the housing 49 of LIDAR device 18 in the same manner as the reflected beam. This mixed light containing both the reflected beam and the visible light sample is known as a commingled light sample.

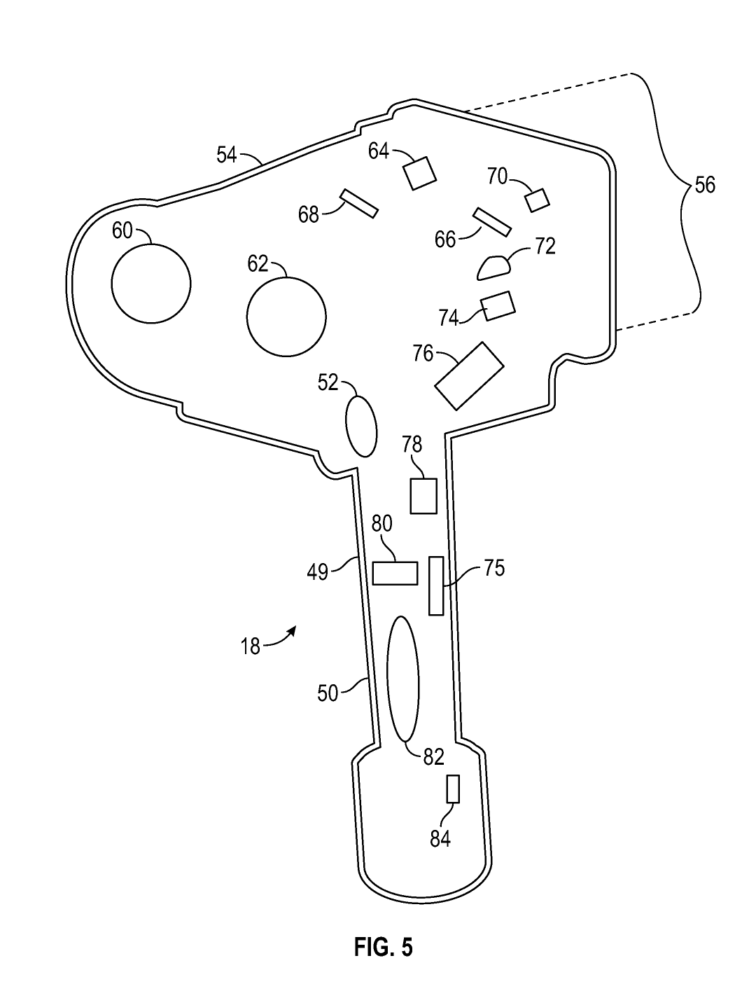

Trigger portion 52 may be depressed by a user to trigger a speed measurement and image generation of a target object. Specifically, a tap, hold, or other activation of trigger portion 52 may initiate methods discussed below for generating a transmission beam, measuring the speed of a target object, and generating a still and/or moving image of the target object. As discussed above, a particular activation of trigger portion 52 may be operable, in some embodiments, to generate a still or moving image on visual display 56 to assist a user in targeting a selected object. In use, device 18 may be held by one or two hands about handle portion 50, such that one or more fingers of an officer can comfortably activate trigger portion 52. Handle portion 50 may be textured with a material such as rubber or molded plastic to create a high-friction grip that is both comfortable and highly durable. Activation of the trigger portion 52 may initiate generation of transmission beam at beam source 64 (FIG. 5) to measure the speed of a target object, as well as generate metadata related to the measurement.

Turning to FIG. 5, a block diagram illustrating elements included in embodiments of the invention includes transmission lens 60, reception lens 62, beam source 64, first beam splitter 66 and second beam splitter 68, beam receiver 70, lens assembly 72, photodiode 74, location sensing element 75, processor 76, non-volatile memory unit 78, communications module 80, power source 82, and external port 84. All of these elements may be wholly or partially contained within the housing 49 of LIDAR device 18, though the locations of each as illustrated in FIG. 5 are meant only for example. In embodiments of the invention, any particular element listed may be shaped or positioned differently, or may be absent altogether.

Beam source 64 is operable to generate a transmission beam for projection at a target vehicle and subsequent analysis of the reflected beam to perform a speed calculation. The beam source 64 may, in some embodiments, generate a laser such as an infrared laser. While a laser generated at a wavelength within the visible spectrum would suffice for the purpose of speed calculation, use of an infrared laser avoids undesired damaging effects that visible lasers may have on the eyes of motorists, pedestrians, or bystanders. The transmission beam is then directed at a target, such as a moving vehicle, via transmission lens 60. Prior to passage through transmission lens 60, in some embodiments the transmission beam may pass through a beam splitter 68 for uniformity with the reflected beam's passage through beam splitter 66, as discussed below.

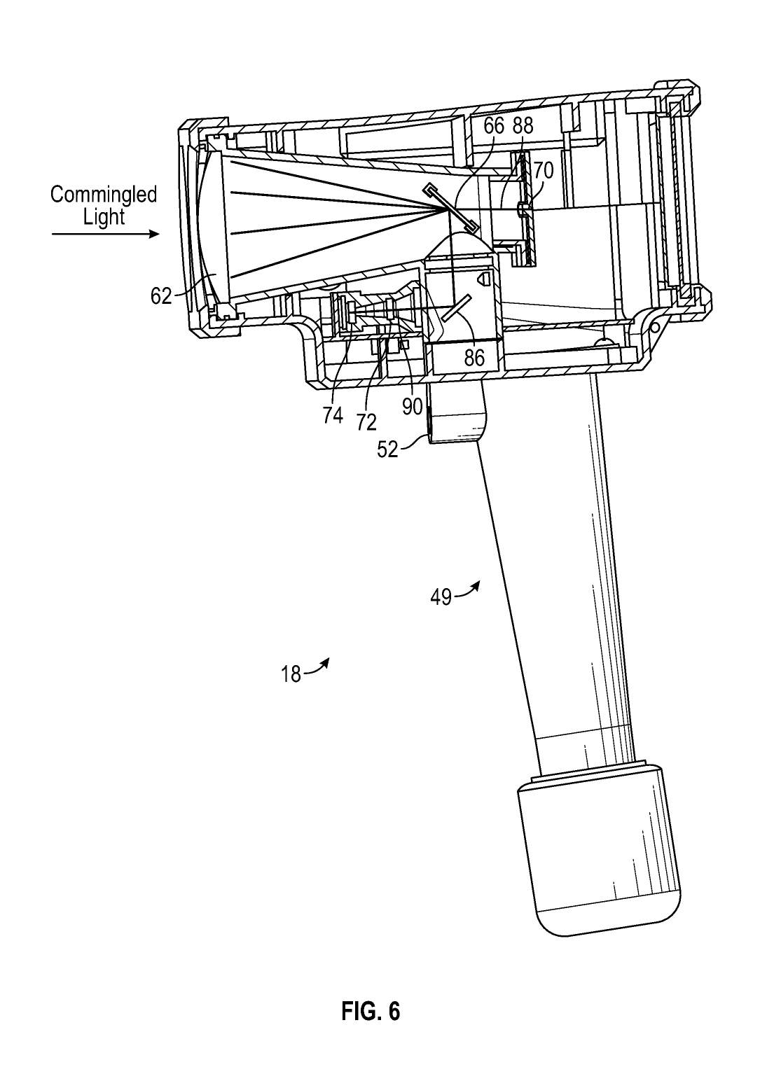

After passage through transmission lens 60, the transmission beam strikes the target and is reflected as a reflected beam towards LIDAR device 18. As illustrated in FIG. 6, the reflected beam passes back into the housing 49 of LIDAR device 18 through reception lens 62, along with a visible light sample from the scene. The visible light sample includes visible light reflected from the target, which lies substantially at the center of the scene. The reflected beam and visible light sample, collectively termed a commingled light sample, is focused by reception lens 60. In some embodiments, the focal point of reflection lens 60 may be at the position of beam splitter 66.

Beam splitter 66 is operable to split the reflected beam 88 (as seen in FIG. 6) from the commingled light sample and direct it towards the beam receiver 70. In some embodiments, as is illustrated in FIG. 5, this may be done by simply allowing the passage of the reflected beam portion 88 of the commingled light sample directly through beam splitter 66, but this construction is not meant to be limiting. In alternative embodiments, the reflected beam 88 may be split from the commingled light sample at beam splitter 66 and directed at an angle towards beam receiver 70. In either case, the reflected beam 88 is captured by the beam receiver 70 and may then be analyzed by processor 76 to calculate the speed of the target object. The calculation of the target object's speed may be performed using typical LIDAR techniques based on the Doppler effect or may alternatively involve time-of-flight measurements and complex object tracking. The speed calculation performed within processor 76 may use any applicable calculations based on a comparison between known parameters of the transmitted beam and measured parameters of the reflected beam.

Beam splitter 66 is further operable to split the visible light sample 90 from the commingled light sample and direct it towards the photodiode 74 through lens assembly 72. In some embodiments, as is illustrated in FIG. 6, this may be done by reflecting the visible light sample 90 at an angle towards beam splitter 66, but this construction is not meant to be limiting. In alternative embodiments, beam splitter 66 may simply allow the direct passage of the visible light sample portion 90 of the commingled light sample. In either case, the visible light sample is captured by the photodiode 74. In the embodiment illustrated in FIG. 6, the visible light sample 90 is further redirected into the photodiode 74 by reflection from a mirror 86. This structure is employed simply for the purpose of efficient utilization of the available space within the housing 49 of LIDAR device 18, and is not meant to be limiting. Any combination of any number of additional mirrors for redirecting the visible light sample 90 and/or reflected beam 88 towards their respective final destinations of photodiode 74 and beam receiver 70 is intended to be included within embodiments of the invention.

A processor may then generate a still and/or moving image from the captured visible light sample 90. This processor may be the same processor 76 as was used to calculate the speed of the target, or may be a separate processor contained within the housing 49 of LIDAR device 18. The processor 76 may also operate to store the calculated speed, generated image, and/or metadata related to the speed measurement and image capture in non-volatile memory unit 78. Metadata may include information such as position, date, or time data, and/or may include a location drawn from location sensing element 75. Location sensing element 75 may be a GPS sensor, or may alternatively be any other form of location sensor. Metadata may further include information associating in memory the calculated speed and generated image. Such metadata may include an identification number, date and/or time stamp, location in memory, filename, officer name or identification number, etc. Any metadata that assists a user in accessing the calculated speed and captured image as a pair may be included in the associating metadata.

The generated image, calculated speed of the object, and/or metadata relating the two may be transmitted to a remote location such as recording device manager 12 by communications module 80. Communications module 80 may transmit and/or receive messages via any known communication protocol, such as Bluetooth™ The communications module 80 comprises a transmitter and may also comprise a receiver, able to communicate with recording device manager 12 in a bidirectional manner. The metadata, generated image, and/or calculated speed of the object may be transmitted as a single file or may be transmitted individually. For instance, the speed may be transmitted instantly while a video of the scene is still being generated from the visible light sample captured by photodiode 74. Alternatively and/or additionally, communication of control data and/or captured and generated data may be transmitted between recording device manager 12 and LIDAR device 18 via a wired connection utilizing external port 84. For instance, external port 84 may be a standard USB port capable of transmitting data between recording device manager 12 and LIDAR device 18 as well as supplying power to LIDAR device 18. This is not meant to be limiting; any type of wired communication with recording device manager 12 is intended for inclusion within embodiments of the invention.

The calculated speed, generated image, and metadata may then be stored by recording device manager 12 in a memory of external computing device 22 located in the police vehicle 16. The recording devices 14, 18 may alternatively or additionally be allowed to upload recordings to an external server or storage device. The external server or storage device could be a large-capacity storage device 28, such as a solid-state hard drive housed in the vehicle, or may be a centralized computing device, such as housed at a police precinct. These examples are not meant to be limiting; any form of data storage and duplication is intended within embodiments of the invention.

Any or all of the elements discussed may be powered from power stored in power source 82. Power source 82 may comprise any form of power storage, such as a capacitor, chemical battery, or rechargeable lithium-ion battery. Additionally and/or alternatively, the components of LIDAR device 18 may draw power from an external power source such as the battery of police vehicle 16, a generator, or a portable external source of power via external port 84. Power source 82 may be charged by a wired connection, such as USB, via external port 84 to later be disconnected and used in a wireless manner.

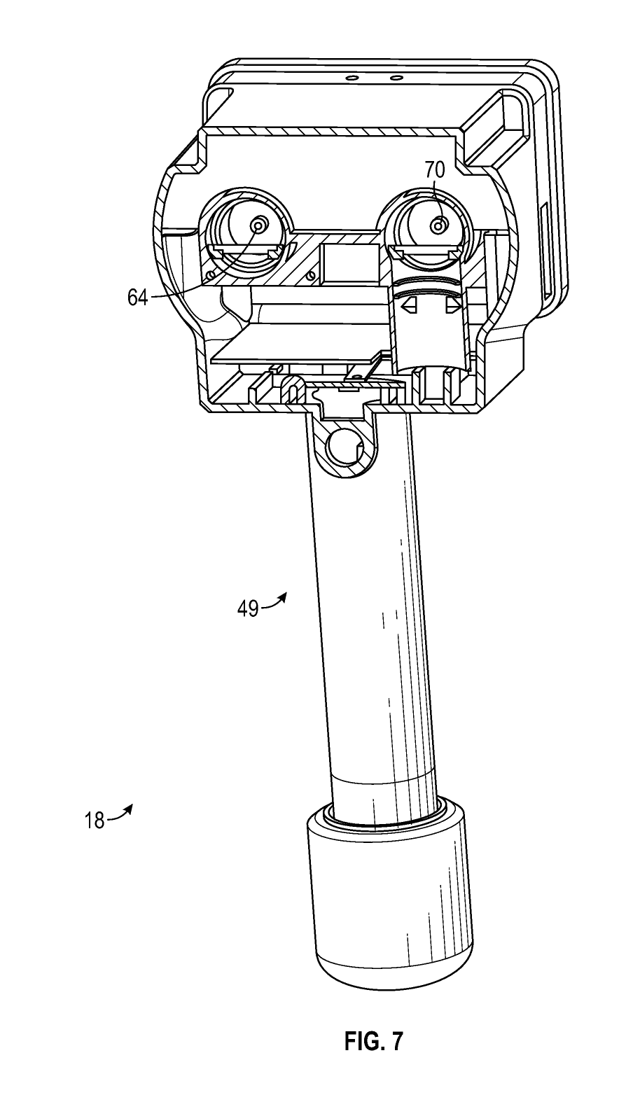

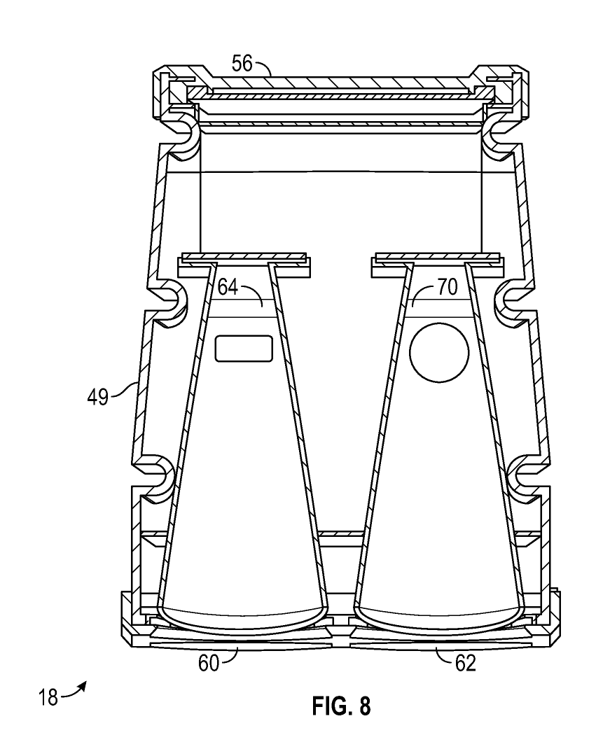

FIGS. 7 and 8 display additional perspectives for understanding the structure of embodiments of LIDAR device 18. While transmission beam 64 is displaced laterally by a small amount (approximately 1-3 inches) from the collection of the commingled light sample by the reception lens 62, LIDAR device 18 will usually be operated at such large displacement from the target moving object that the displacement distance will be negligible. This means that the transmission beam and reflected beam will travel nearly parallel paths into and out of LIDAR device 18. The displayed orientations of transmission lens 60 and reception lens 62 are intended only as example. Their positions, as well as those of the beam source 64, beam splitter 66, beam receiver 70, photodiode 74, etc. could be reversed, vertically oriented, or positioned in any other manner and still be included within embodiments of the invention.

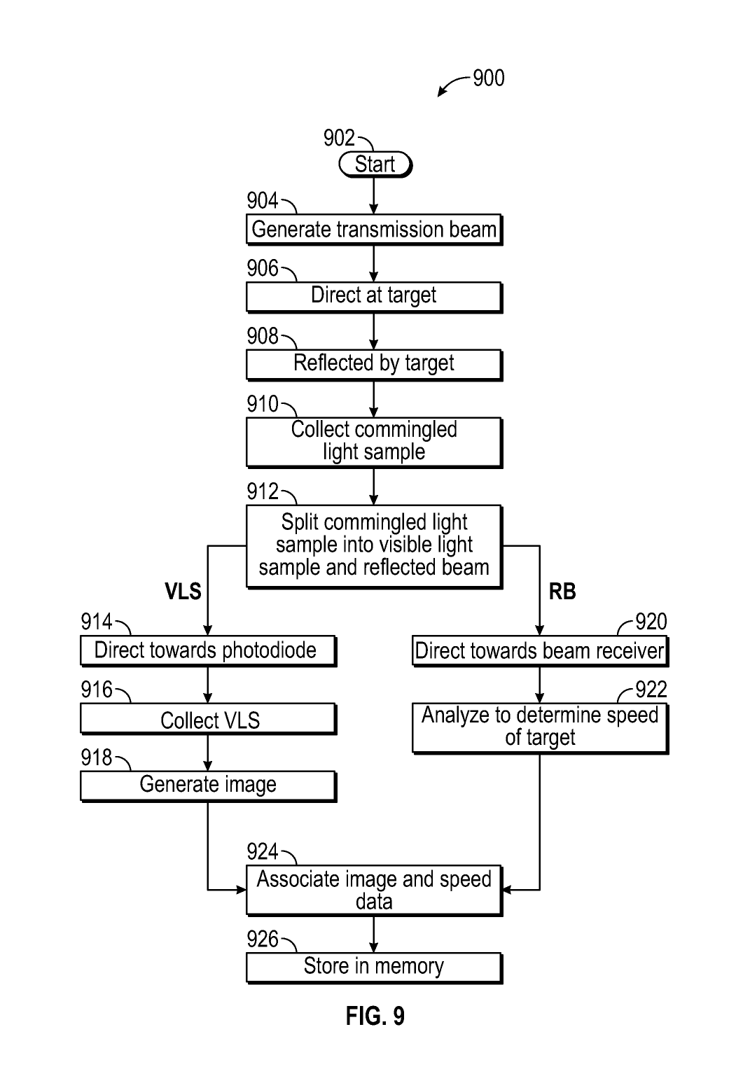

While reference has been made above to the various components and techniques of embodiments of the invention, the description that follows will provide further examples systems and processes that may be added in embodiments of the invention. The description below is intended to merely exemplify steps that may be taken in practice of operation of embodiments of the invention and is not intended to be limiting. Steps that may be performed in practice of some embodiments of the invention are illustrated in FIG. 9 and herein described.

Speed determination and object imaging method 900 begins at step 902, in which a speed determination and image generation is initiated. This initiation may be in response to a user's manual depression of a control, such as trigger portion 52 of FIGS. 2-5. Alternatively, method 900 may be initiated automatically by the system in response to one or more triggering events. Examples of a triggering event may include, for example, turning on the police vehicle's 16 siren and/or signal lights, an indication that a patrol car is parked, a computer detection of a subject car or license plate, a position of the vehicle and/or officer as measured by a GPS, expiration of a timer, a remote command, etc.

In embodiments, the recording device manager 12 may receive a signal from, for example, the vehicle recording device 14, external computing device 22, or police vehicle 16 indicative of a triggering event. In response to receipt of the signal, or based on a type of triggering event as evidenced by the signal, the recording device manager 12 may instruct a measurement and image capture by LIDAR device 18. As an exemplary scenario, the recording device manager may receive a signal identifying a triggering event of a police vehicle 16 being put in park and subsequent identification of a passing license plate. Upon receipt of the signal, the recording device manager 12 sends a signal to LIDAR device 18 to instruct the device 18 to begin a the steps of method 900. It should be appreciated that other types of triggering events and exemplary scenarios can be employed.

Regardless of the cause, an initiation of the method at step 902 causes a transmission beam to be generated in step 904 at beam source 64 of FIG. 5. The generated transmission beam may be a laser, and in particular may be an infrared laser. The transmission beam may pass through a beam splitter 68 as it exits the housing 49 of LIDAR device 18 at transmission lens 60 in step 906. Specifically, this beam splitter may be positioned between the beam source and the transmission lens. The transmission beam then travels the intervening space between LIDAR device 18 and a target object, which for purposes of this explanation will be exemplified as a moving vehicle. The transmission beam falls incident on the moving vehicle and is reflected back towards LIDAR device 18 in step 908. At this point, the beam will become a reflected beam with an adjusted wavelength based on the difference in the relative speeds of the target moving vehicle and LIDAR device 18. In practice, LIDAR device 18 will usually be at rest, but in some embodiments LIDAR device 18 may be operated through method 900 while in motion. In such embodiments, processor 76 may take into receive a sensed speed of the device 18 and/or police vehicle 16, and account for such in its calculation of the speed of the target moving vehicle. The sensed speed may come from the speedometer of police vehicle 16 or may be extrapolated from the readings of a location sensing element 75 based in LIDAR device 18 or alternatively in police vehicle 16.

After reflection from the target vehicle at step 908, the reflected beam then travels back across the intervening space between the target moving vehicle and LIDAR device 18. There, the reflected beam is collected back into the housing 49 along with a visible light sample of the scene via reception lens 62 at step 910 as a commingled light sample. Inside the housing 49, the commingled light sample may be focused on the surface of a beam splitter 66. Beam splitter 66 may be a partially silvered mirror, which selectively permits the passage of the reflected beam 88 and reflects the visible light sample 90 at step 912. Alternatively, the beam splitter may be constructed of a combination of prisms with differing refractive indices, a thin film deposit on a plastic base, or any other appropriate construction for separating and directing the reflected beam and visible light sample at step 912. Each of these constructions is intended for inclusion within embodiments of the invention.

The left side of FIG. 9 then follows the steps performed on the visible light sample 90. The visible light sample 90 is directed towards photodiode 74 in step 914. Before reaching photodiode 74, it may pass through lens assembly 72, operable to focus, filter, and/or otherwise modify the visible light sample prior to capture. Processor 76 may be configured to adjust the focus or filtering properties of lens assembly 72 automatically or in response to user input. At step 916, the photodiode 74 captures the visible light sample 90 and supplies it to processor 76. At step 918, processor 76 processes the captured visible light sample and generates one or more images of the scene, including the target moving vehicle. Step 18 may include generation of still images, video images, or both. The processor 76 may perform additional graphical processing steps on the generated image(s) to further focus, balance, or otherwise improve the quality of the captured still or video image.

Correspondingly, the right side of FIG. 9 follows the steps performed on the reflected beam 88. The reflected beam 88 is directed towards beam receiver 70 in step 920. The beam receiver 70 is operable to capture the reflected beam 88 and supply it to processor 76. Alternatively, it may supply the captured reflected beam 88 to another processor in LIDAR device 18 or external computing device 22 via communications module 80 or external port 84. At step 922, the speed of the target moving vehicle is determined based on the captured reflected beam, sensed parameters, and/or known values of parameters of the transmitted beam.

At step 924, the image generated in step 918 and the speed calculated in step 922 are associated with metadata, which may include a file name, alphanumeric ID, location in memory, date, time, officer name, badge number, and/or geographic location. The image, speed, and any metadata are then stored in non-volatile memory unit 78 in step 926. Additionally, the image, speed, and any metadata may be transferred at this point to recording device manager 12 via transmitter 80 or external port 84. They may then be stored in large-capacity storage device 28 and/or memory contained in external computing device 22. They may further be transferred to a remote location that may contain a centralized computing device, such as a central server housed at a police precinct.

It should be appreciated that, while the above disclosure is directed mainly to the field of law enforcement, some embodiments of the invention may be employed for any pursuit requiring reliable speed determination and object imaging. Embodiments of the invention may be used in any setting or field, such as military or marine applications, to calculate the speed of an object while simultaneously capturing its image. Embodiments of the invention may be used by private individuals or businesses to reliably calculate and prove the speed of objects. Embodiments of the invention may be used to capture video and determine speed related to performances of athletes, such as in gauging the speed of a bat speed of a baseball player at bat. The law enforcement field discussed is merely exemplary and should not be construed as limiting.

Having thus described various embodiments of the invention, what is claimed as new and desired to be protected by Letters Patent includes the following:

1. A system for imaging an object and determining the speed of the object, the system comprising:
a beam source operable to generate a transmission beam;
a first lens configured to collect a commingled light sample including a visible light sample and a reflected beam,
wherein the reflected beam is a reflection of the transmission beam from the object;
a beam receiver operable to capture the reflected beam;
a photodiode operable to capture the visible light sample;
a first beam splitter configured to direct the reflected beam towards the beam receiver and to direct the visible light sample towards the photodiode; and
a first processor operable to analyze the reflected beam to calculate the speed of the object.

2. The system of claim 1, wherein the transmission beam is directed towards the object through a second lens.

3. The system of claim 1, wherein a second processor produces an image of the object from the visible light sample captured by the photodiode.

4. The system of claim 3, wherein the second processor is the first processor.

5. The system of claim 3, further comprising a communications module operable to transmit the image of the object and the speed of the object to a remote location.

6. The system of claim 3, wherein the image of the object is a video image.

7. The system of claim 3, wherein the image of the object is a still image.

8. The system of claim 3, further including a visual display operable to display the speed of the object.

9. The system of claim 8, wherein the visual display is further operable to display the image of the object

10. The system of claim 1, wherein the first beam splitter is configured to permit passage of the reflected beam and reflect the visible light sample.

11. The system of claim 1, further comprising a second beam splitter positioned between the beam source and the second lens.

12. The system of claim 1, wherein the transmission beam is an infrared laser.

13. The system of claim 1, further comprising a housing including a handle portion, a trigger portion, and a head portion, the housing containing the beam source, first lens, beam receiver, photodiode, first beam splitter, and first processor.

14. The system of claim 1, further comprising a non-volatile memory unit operable to store the image of the object and the speed of the object.

15. The system of claim 1, further comprising a lens assembly for focusing the visible light sample prior to capture by the photodiode.

16. A method of imaging and determining the speed of an object, the method comprising:
generating a transmission beam using a beam source;
collecting a commingled light sample;
splitting the commingled light sample into a visible light sample and a reflected beam,
wherein the reflected beam is a reflection of the transmission beam from the object;
directing the reflected beam towards a beam receiver;
directing the visible light signal towards a photodiode;
analyzing the reflected beam to determine the speed of the object using a processor; and
generating an image of the object from the visible light sample collected by the photodiode.

17. The method of claim 16, further comprising the steps of:
storing the image of the object in a non-volatile memory unit;
storing the speed of the object in the non-volatile memory unit; and
storing metadata associating the image of the object and the speed of the object.

18. The method of claim 16, wherein the transmission beam is generated in response to a manual selection.

19. The method of claim 16, further comprising the step of transmitting the image of the object and the speed of the object to a recording device manager.

20. A shared-perspective LIDAR system for imaging and determining the speed of an object, the system comprising:
a beam source operable to generate a transmission beam;
a lens configured to collect a commingled light sample including a visible light sample and a reflected beam,
wherein the reflected beam is a reflection of the transmission beam from the object;
a beam receiver operable to capture the reflected beam;
a photodiode operable to capture the visible light sample;
a beam splitter configured to direct the reflected beam towards the beam receiver and direct the visible light sample towards the photodiode;
a processing assembly operable to analyze the reflected beam to calculate the speed of the object and further operable to produce an image of the object from the visible light sample captured by the photodiode;
a non-volatile memory unit; and
a recording device manager operable to store the speed of the object and the image of the object in the non-volatile memory unit.
